(19) United States
(12) Patent Application Publication
(10) Pub. No.: US 2006/0288099 A1
(43) Pub. Date: Dec. 21, 2006

(54) Method of and System for Presence Management in Telecommunications

(75) Inventors: Todd Jefferson, Manotick (CA); Yanick Dufresne, Ottawa (CA); Andrew Hackston, Ottawa (CA); Noam David Tomczak, Ottawa (CA); Alec Saunders, Manotick (CA); Howard H. Thaw, Green Valley (CA)

Correspondence Address: BUCKINGHAM, DOOLITTLE & BURROUGHS, LLP, 50 S. MAIN STREET, AKRON, OH, 44308, US

(73) Assignee: Iotum Corporation, a Delaware corporation, Ottawa (CA)

(21) Appl. No.: 11/382,130

(22) Filed: May 8, 2006

(30) Foreign Application Priority Data
May 6, 2005 (CA) 2,506,665

(51) Int. Cl. G06F 15/173

(52) U.S. Cl. 709/224

(57) ABSTRACT

The present invention relates to telecommunication systems and more specifically, to a method of and system for responding to inquiries regarding user presence with respect to various communication systems. The invention provides a method of responding to a presence inquiry for a given user which includes the steps of establishing context parameters for the user, establishing rules to govern responses to presence inquiries, the rules relying on values/states of the context parameters, and determining values/states of context parameters at the time of the presence inquiry, including identifying the party making said inquiry. A presence response is then established with respect to the established rules and the values/states of the context parameters at time of the presence inquiry This presence response is then reported to the inquiring party.

### FIELD OF INVENTION

The present invention relates to telecommunication systems and more specifically, to a method of and system for responding to inquiries regarding user presence with respect to various communication systems

### BACKGROUND OF THE INVENTION

The architecture of the traditional voice communication network, the public switched telephone network (PSTN), has been merging with the Internet and is driving a sweeping set of changes in communication services. IP (Internet Protocol) Communications refers to the integration of data, voice, call management and video solutions onto a single, Internet Protocol based network. IP Communications has radically changed the way people communicate, and the way telecommunication networks operate.

Voice over IP (VoIP) technology, for example—the transmission of voice as packets over IP networks—is a major step in the transformation of the communications industry currently underway. VoIP is opening the door to smart communication devices that are transforming the communications experience. Users are becoming able to access diverse media, including voice, e-mail, instant messaging, Web sites, video, applications and data, not only from their desktops and notebooks, but also from cell phones, desk phones, personal digital assistants (PDAs), entertainment devices such as set top boxes and other similar devices. However, the new functionality is also introducing new problems and new user expectations that ate difficult to manage.

Instant messaging (IM), for example, is a commonly used text communication application that can be a great convenience when all of the relevant patties are available and happy to become involved in communication. However, if a party is not available or is working on a higher priority issue, it can be source of aggravation.

IM is an Internet-based communication service that allows a user to share a private chat room with another individual The IM service maintains a “buddy list” or “contact list” for each user and notifies the user when one of their pre-authorized contacts is online. The user is then able to initiate a chat session with that individual if they wish, a small window being launched that both parties can see and type in

IM offers two major advantages over email. Firstly, with email, the user does not know whether the recipient of an email message is online, so they do not know whether the recipient received it, let alone when. With IM, the sender knows that the recipient is online and can reasonably expect that his message popped up on the recipient's computer screen. Secondly, if the two parties are in the process of sending many messages back and forth, there are generally more steps required with email in order to read, reply and send a new email message—IM is much quicker in this respect.

The concept of the IM system reporting that a given user is available for communication is referred to as “presence”. As shown in FIG. 1, the usual process is that a user will make their online/offline and available/busy status available to the IM Server 12, who stores this data 14 and makes it available to a list of authenticated Watchers. Two exemplary Watchers 16 and 18 are shown in FIG. 1, but there may be many in a large IM service. When the user's presence changes, for example, the user goes offline, the Watchers 16, 18 are notified of the new state of the user's presence.

Availability information is important in many personal and business circumstances. Publishing of accurate presence information enables more efficient communication between patties because they will know whether an attempt to communicate will be successful. For example, a customer may wish to communicate with an account representative immediately rather than waiting for a response to a voicemail message or email If the presence of all of his account representatives is available via IM, then he may be able to identify someone who is available and contact him immediately. However, IM may not be the customer's preferred means of communication, and “presence” systems are not available for communication systems other than IM.

As well, in current approaches to presence publishing, the user will publish the same presence to all of the Watchers. If a user is available then they are available for all Watchers (provided that the Watchers are authorized to access the information and make it available). As shown in FIG. 1, both Watchers 16, 18 will receive the same presence information. However, at certain times a user may wish to appear available to one Watcher but unavailable to another. For example, a user may wish to be available to his co-workers or his customers at a certain corporation, but unavailable to his casual friends. There is currently no support for such functionality.

A user's presence may also depend on other contextual sources such as time of day and activity. For example, during regular working hours, a user may wish to be available to co-workers but unavailable to friends. Current IM systems have no way of accommodating such preferences and context such as time of day

There is therefore a need for a system that can publish different presence states to different Watchers with respect to various communication systems, and furthermore, to accommodate variances in other influential factors in deciding how to report availability. This system should be dynamic and provide the user with controls to dictate how he would like to implement his system.

### SUMMARY OF THE INVENTION

It is therefore an object of the invention to provide an improved method of and system for presence management in telecommunications which obviates or mitigates at least one of the disadvantages described above.

The method of and system for presence management allows the user to publish selective personal information to authorized Watchers or any other individual, for any communication service including telephone, IM, email, video, and the like. The underlying concept is the idea of collecting contextual information about users and building intelligent rules to make decisions based on that context. Presence is therefore reported selectively, some Watchers being advised that the user's presence is in one state, while other Watchers are advised that the user's presence is in another state.

Physical presence alone is not context. The less contextually aware, the less automated control can be. Knowing the physical presence state of a contact is a first step, but contextual awareness requires a lot more than physical presence. Contextual awareness is the set of facts or circumstances that surround a situation. Contextual awareness represents the awareness of the applications of the context based on factors including, for example: physical presence, day and time, current activity, who is the watcher, environment, place, relationship and user preferences. Users can define rules for managing presence notifications based on a number of contextual criteria.

For example, a user may be in a meeting with a co-worker. The presence he may wish to publish to his boss or co-workers might be “Available, but in a meeting”, while he may wish to report his presence to his friends as “Unavailable”. He may wish to report to his closer personal contacts such as his spouse, that he is “Unavailable, in a meeting at the office”. In such an example, the presence is dependent on what the user is doing and who is making the presence inquiry.

One aspect of the invention is broadly defined as a method of responding to a presence inquiry for a given user comprising the steps of: establishing context parameters for the user; establishing rules to govern responses to presence inquiries, the rules relying on values/states of the context parameters; determining values/states of context parameters at time of the presence inquiry, including identifying the party making the inquiry; establishing a presence response with respect to the established rules and the values/states of context parameters at time of the presence inquiry; and reporting the presence response to the inquiring party.

Another aspect of the invention is broadly defined as a telecommunications system comprising: a telecommunications network; a plurality of User interface devices; means for enabling the End User to set up rules for governing presence publishing; means for establishing contextual parameters for the End User; and means for coordinating communications between the telecommunications network and the plurality of User interface devices, with consideration for the contextual state of an End User

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 presents a block diagram of an exemplary IM Watcher system as known in the art;

FIG. 2 presents a block diagram of an exemplary IM Watcher system in an embodiment of the invention;

FIG. 3 presents a state diagram of an exemplary context and rules generating system in an embodiment of the invention;

FIG. 4 presents a state diagram of an exemplary response to a presence inquiry in an embodiment of the invention;

FIG. 5 presents a block diagram of an exemplary system of the invention;

FIG. 6 presents a block diagram of a general architecture for a server in an embodiment of the invention;

FIG. 7 presents a block diagram of a specific architecture for a server in an embodiment of the invention;

FIG. 8 presents an exemplary client interface for the development of call control rules in an embodiment of the invention;

FIG. 9 presents a process flow diagram for the viewing and editing of rules, in an embodiment of the invention;

FIG. 10 presents a process flow diagram for process context updates from a wireless device, in an embodiment of the invention; and

FIG. 11 presents a process flow diagram for administrative console interaction, in an embodiment of the invention.

### DESCRIPTION OF PREFERRED EMBODIMENTS OF THE INVENTION

The above described problems can be addressed by employing a system and method as described hereinafter and presented in FIGS. 2 through 11.

As explained above, the system of the invention collects context information regarding a User's available communication channels, and uses rules established by the User to determine how to represent the User's presence to outside Watchers. In some cases the outside Watcher may be an online service, such as those related to IM services, while in other cases, the Watcher may be a corporation or an individual.

For example, suppose that Watcher Joe is on user Jane's VIP list, but Watcher Stan is not. Further, Jane's calendar indicates she is currently in a meeting. Jane's rules may require that when her calendar shows she is in a meeting, she is busy, but allows VIPs to interrupt her. Thus, her presence will be shown as follows:
1) to Watcher Joe, her presence will be “busy, but interruptable”; while
2) to Watcher Stan, her presence will be “busy, and unavailable”.

The invention is described with respect to particular examples, but it will become clear that the invention may be implemented on various platforms. For example, it may be centered around a server, client, web application, ASP (application service provider), integrated with another device such as a VoIP telephone or PBX card, or provided as a separate, stand-alone system. Each has its own advantages and disadvantages, and the decision on which to use will generally change with the situation of the user.

A presence server can also be implemented in any number of ways, for example, building on SIMPLE or other standards currently available SIMPLE (session initiation protocol for instant messaging and presence leveraging extensions) is an application of the SIP protocol for server-to-server and client-server interoperability in instant messaging. SIP (session initiation protocol) is an application layer control protocol signaling protocol for Internet Telephony. It is used to establish audio and video connections, call forwarding and other fundamental telephony features.

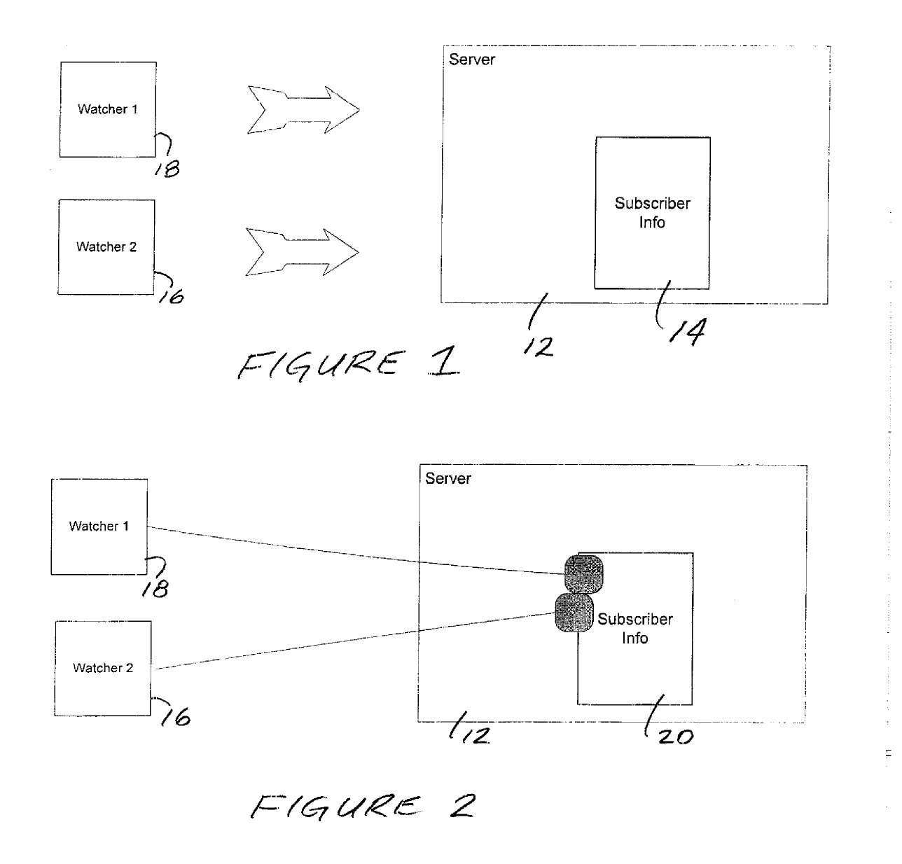

As noted above with respect to FIG. 1, the typical presence reporting model incorporates a number of Watchers 16, 18 all of whom receive and publish the same presence information for a given user. In contrast, when the method and system of the invention is employed, a separate assessment is made for each Watcher 16, 18 and it is possible that each Watcher 16, 18 will receive different presence information, as shown in FIG. 2 where the user information 20 consists of separate data for the different Watchers. This may be due to many reasons, for example, Watcher 16 may be on the user's VIP list, while Watcher 18 is not, and the user has a rule which treats the two Watchers differently.

Also, when the user updates some of their context information, this may change the Presence Status for a given Watcher. For example, if the user goes into a VIP meeting as recorded in his Microsoft Outlook Calendar; the system may determine that the Watcher 16 may now interrupt the user (because Watcher 16 is on the VIP list), but it will advise Watcher 18 that the user is now busy (because Watcher 18 is not on the VIP list).

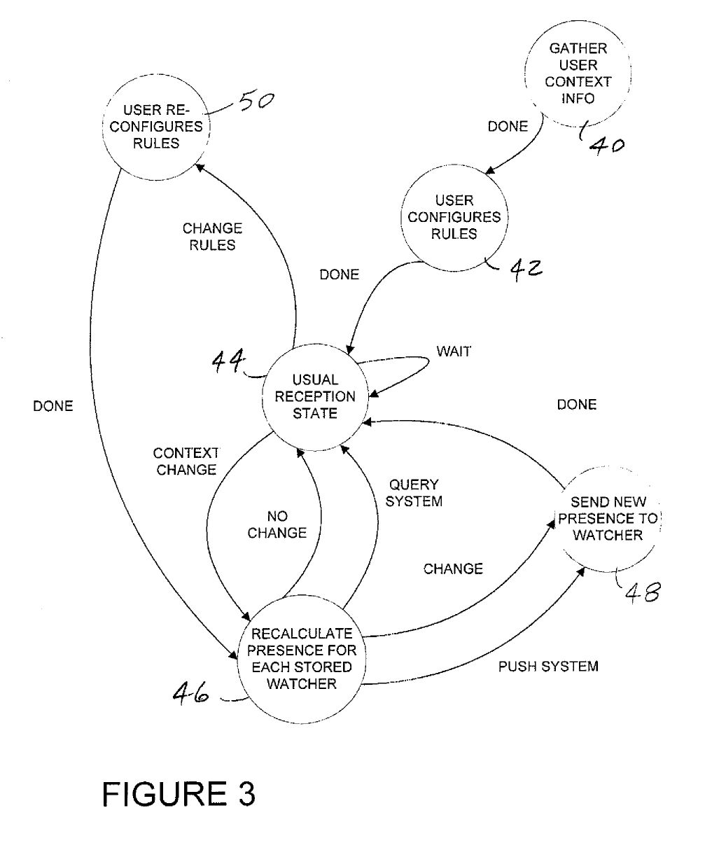

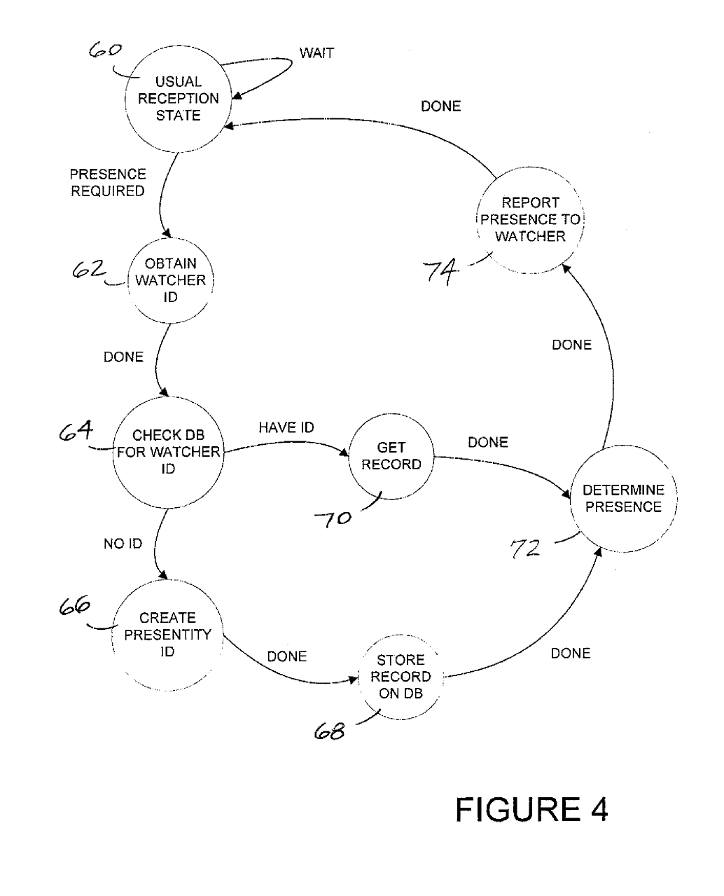

FIGS. 3 and 4 present state-diagrams of an exemplary method of implementing such a system, FIG. 3 presenting the client-side maintenance of the rules and context information and FIG. 4 presenting the processing that occurs in response to a presence query.

The process begins with the gathering of user context information at state 40 of FIG. 3. This context information will be collected both automatically and manually. For example, the user may be able to manually click on a box in a graphic user interface (GUI) which reads “do not disturb”, while he is having lunch or is participating in an ad hoc meeting with his boss. He may also click on various manual overrides such as: available, busy, busy but interruptible, do not disturb, out of the office, or on vacation.

As well, context information may be collected automatically from various sources such as:
meetings recorded in Microsoft Outlook;
checking the time of day either online or on a local clock;
determining the users physical location;
collecting presence status from other services; or
accessing stored lists of acceptable Watchers in user's groups.
   Typically, the information will be collected using add-ons, software modules which are added to existing applications to provide access to the data that they require. Microsoft Exchange, Yahoo Messenger, MSN Messenger and MS Outlook are all current applications from which contextual data may be obtained.

Contextual data could any piece of information that affects the willingness of a user to communicate with a watcher. Some examples are the on/off hook of various communication devices, GPS location information and ambient noise and environmental information.

Next, at state 42, the User configures his rules, behaviors, and policies for assessing any incoming inquiries. Any number and variety of rules may be established to configure the system, and of course, the rules will vary with the nature of the communication medium. An exemplary set of rules is as follows,
For VIPs, I am always available.
During work hours, I am available for co-workers.
During work hours, I am busy for Friends and Family.
Outside of work hours, I am available for Family.
My wife, always has full access.
During Work Hours, Co-workers have full access.
Outside of work hours, Family has full access.
Authorized contacts have limited access.
Unauthorized contacts have no access.

It is preferable that the system architecture be designed to accommodate both beginners and experienced programmers. For example, the invention will be implemented with a software wizard which steps the user through the available options and has help support. At the same time, more experienced programmers will have the option of generating their own rules, using a scripting language or some similar tool.

The rules in the wizard will generally be established to reflect the most common scenarios and devices. Wizards dedicated to particular industries, professions and hardware systems can be generated and provided with the system. For example, if the user only has connectivity to two or three specific communication systems, it is not logical to present a long list of rules to them regarding other communication systems.

Once the initial context information has been collected at state 40, and the rules established at state 42, the process will sit in a wait state or “general reception state” 44. From the wait state 44, if a change occurs to the user's context, process control passes to state 46 where the presence for each stored Watcher is recalculated in view of the new user context data. As we will explain with respect to FIG. 4, a presence record is stored for each Watcher, so that it can be updated if there is a change to the user's context or his rules. The analysis and calculation of the presence state that should be reported to a given Watcher could be performed in several different ways (such as heuristics, artificial intelligence, neural networks, Bayesian networks, fuzzy logic, etc.), but it is preferable to use an “expert system” model as known in the art. In a “push” system—that is, a system in which presence is proactively forwarded to a service provider or Watcher so that the user's state can be published—the new state is broadcast at state 48 If the system is either a query-handling system in which the system simply responds to queries regarding status, or there is no change to the state of The User's presence, then control simply passes back to the wait state 44.

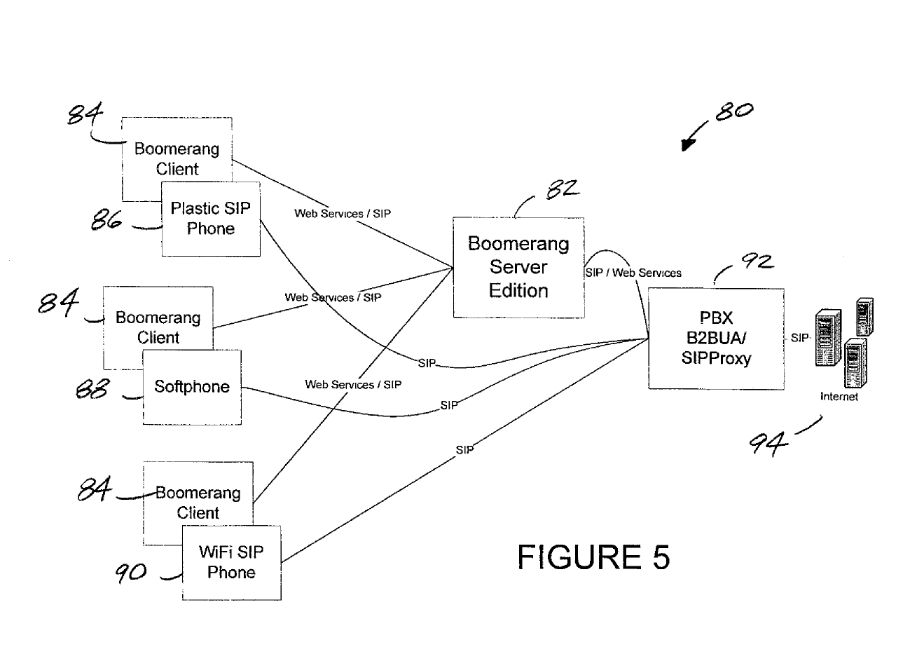

Note that it would only be desirable to issue new presence broadcasts where the presence has actually changed, to save on network resources. To do this, it is necessary that the last reported presence report be stored with respect to each Watcher so that a comparison can be made. As we will note with respect to FIG. 5, a data record indexed by a unique Watch ID is stored for each Watcher to facilitate this.

From the wait state 44, the User may also request that his rules/behaviours/actions/policies/preferences (whichever language is appropriate to the type of analysis being used) be changed. In such a case, control passes to state 50, where the rules wizard is launched again, but as a default, the fields of the wizard are populated as per the User's original data. The User is able to make whatever changes he requires and store the new set of rules. Control passes again to step 46, so that the stored Watcher presence information can be recalculated.

FIG. 5 presents a state diagram of an exemplary presence response method in an embodiment of the invention. As noted with respect to FIG. 4, some implementations of the invention will be “push” systems in which presence data is automatically broadcast to all Watchers. In other systems, it will be necessary to respond to specific requests for presence information. FIG. 5 is intended to show the process for responding to such presence inquiries.

The process will default to a wait state or “reception state” 60. When a Watcher wants to see a User's presence, their client will ask the presence server for a “Presentity ID” based on the User's identifier such as a telephone number; cell number, email address, or other similar personal data appropriate to the nature of the communication presence being requested.

The presence server will then obtain the Watcher's identity at state 62 and check to see whether a data record had been stored in the past which corresponds to this Watcher (or more accurately, to the Watcher's ID), at state 64. If no record had been generated in the past, the presence server will create a Presentity identifier at state 66 which is unique to this Watcher, by relying on or incorporating some attribute of the Watcher's ID. This Presentity identifier is then stored on the database at state 68. Each User will have a Presentity ID for each Watcher. In systems where presence is cached outside the presence server the Presentity ID per watcher will allow these systems to continue to work normally

If it was determined at state 64 that the Watcher already had a data record on the database, then that record is simply obtained at state 70.

In either case, process control now arrives at state 72, where an analysis is performed based on the User's stored rules and context data, to determine what presence status should be reported back to the given Watcher. This analysis will include determining the authentication level of the Watcher's ID, to determine what ‘view’ of the user's presence the Watcher may see. At a simple level the authentication level may be one of: authenticated, unauthenticated or anonymous. Similar to state 46 above, the analysis at state 72 will preferably be performed using an expert system model but could be performed using other models.

The presence report is then sent to the Watcher at state 74, and control returns to the wait state 60.

Many businesses today, must be responsive to communications every day of the week, at any time of day. This is referred to as “Always-On Business”. Our service driven society demands it in order to maximize customer satisfaction and employee productivity, to be responsive to international clientele, and to be responsive to clients who work outside of regular local business hours.

Always-On Business has led to a proliferation of communication methods and technologies, and a culture where interruption is taken for granted. The downsides of being Always-On are (paradoxically) the development of a productivity gap due to the disruptiveness of interruptions, and increasing caller dissatisfaction when the person a caller seeks cannot be found

The invention allows callers to locate people who are available, so that they can quickly make communication connections, and avoid attempting to contact people who are unavailable or interrupting people who are busy with higher priority tasks. It also allows called parties to advise on the most convenient way to contact them at a given point in time For example, if the individual is driving a car, they may wish to indicate that they are available via their hands-free cell phone, but not via wireless email, even though they are using the same physical device for both. Thus, a person wishing to reach them will be directed to the most likely avenue for reaching that person, making that person easier to contact.

The invention allows callers to identify who is available and what medium to use to reach them. Thus, they can make the contact that they need, and the called parties are not interrupted when they are busy with more important tasks. Employers can also audit the availability patterns of their employees to determine whether their clients are being properly accommodated.

As noted above, the invention can be supported at virtually any level in any telecommunication system as it is simply a new and complementary layer. The contextual awareness it provides would add value to any SIP compliant end point (IP phones, soft-phones) for example, or any IP-PBXs.

The Internet is currently the most effective medium for the ultimate transmission of the presence information to calling parties, but that is simply because the Internet currently offers a pervasive, rich, real-time interface. If another communication medium was to overcome the Internet in respect of these advantages, the invention could easily be ported to it.

The method could, for example, be implement on a client, a server; an ASP, or as a separate physical box In the case of implementation on a traditional PBX private branch exchange), one could add a physical card to the PBX to monitor the status of the PBX users and provide this data to the Internet. The presence analysis could be run on the physical card itself, the card acting as a web server for reporting to Watchers over the Internet, or the analysis could be run on a separate server or via an ASP.

The invention is interoperable with all manners of telecommunication devices and related productivity applications including Customer Premises Equipment, hosted providers, softphones, IP-PBX phones and assisted communication systems. Assisted communication systems are client server applications which assume intelligent end points, and highly programmable PBX capabilities. The invention can also be implemented with any number or manner of end devices including SIP enabled endpoints, IP phones, PCs, laptops, personal digital assistants (PDAs), and cell phones.

Assisted communication is a new segment, the focus of which is context and user empowerment. The goal is to help the user control their level of interruption by providing automated control of calls based on context.

Traditional PBX platforms and many of today's generation of EP PBX platforms, assume the use of a “dumb” endpoint. As these products evolve, more and more of the capabilities of the endpoint are being exploited, such as presence. Sales of IP enabled PBXs are expected to exceed those of traditional PBX in 2005. IP enabled PBXs are convergence products designed to exploit the potential of single network merged data and voice. This market will likely shift away from proprietary architectures and move decisively to SIP, despite the fact that most of the vendors today are delivering either proprietary MGCP or H 323 solutions. Nonetheless, the invention is applicable to all of these environments. As well, the system and method of the invention may be offered as a stand-alone offering independent of the underlying communication system, or integrated with it.

A high level overview of an exemplary system 80 is presented in FIG. 5. As shown, the system consists of a “Boomerang” server 82, and PC based “Boomerang” clients 84. The Boomerang clients 84 are desktop PC applications which:
1) allow the user to specify rules for given presence queries;
2) interface desktop context information to the Boomerang server 82; and
3) perform call control between third party phone devices or software, and the local devices 86, 88, 90.
   The Boomerang server 82 aggregates context information, and performs analyses to determine what presence should be reported in response to various presence queries.

Communications between the Boomerang server 82 and Boomerang clients 84 is generally performed using various web services protocols and SIP. Communications between the Boomerang clients 84 and the local communications devices such as plastic SIP phones 86, softphones 88, and WiFi SIP phones 90 is generally via SIP. As shown, the local communications devices 86, 88, 90 may also communicate directly with a local IP PBX 92, which in turn, is connected to the Internet 94.

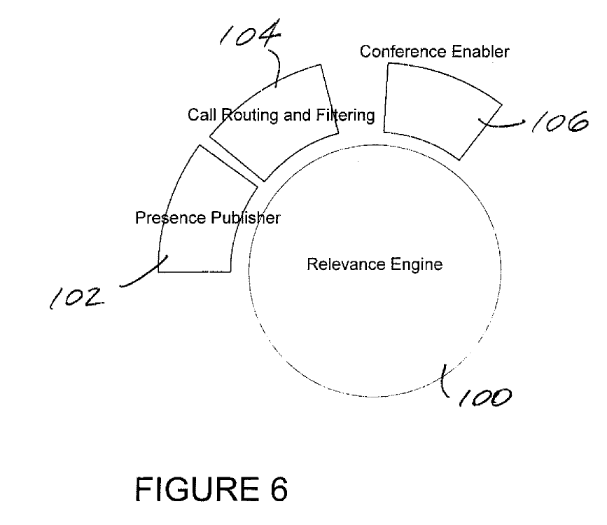

A simplified view of the server architecture is presented in the block diagram of FIG. 6. In short, the server 82 is built around a “relevance engine” 100 which makes decisions based on context and rules. Three external modules are shown in this figure: a presence publisher 102, a call routing and filtering module 104 and a conference enabler 106. All thee of these modules rely on decisions of the relevance engine 100 in operating. For example, calls can be routed using the call routing and filtering module 104 in accordance with the user's context and rules—if the user is busy and a casual acquaintance calls, the call could be directed to voicemail, while the boss's calls would be sent to the user's cell phone. Similarly, the conference call module 106 will patch a specific list of callers into a conference call bridge regardless of which of the user's telephone numbers were dialed, while all other callers are sent to voicemail.

Other modules could also be added, building on the context/rules concept

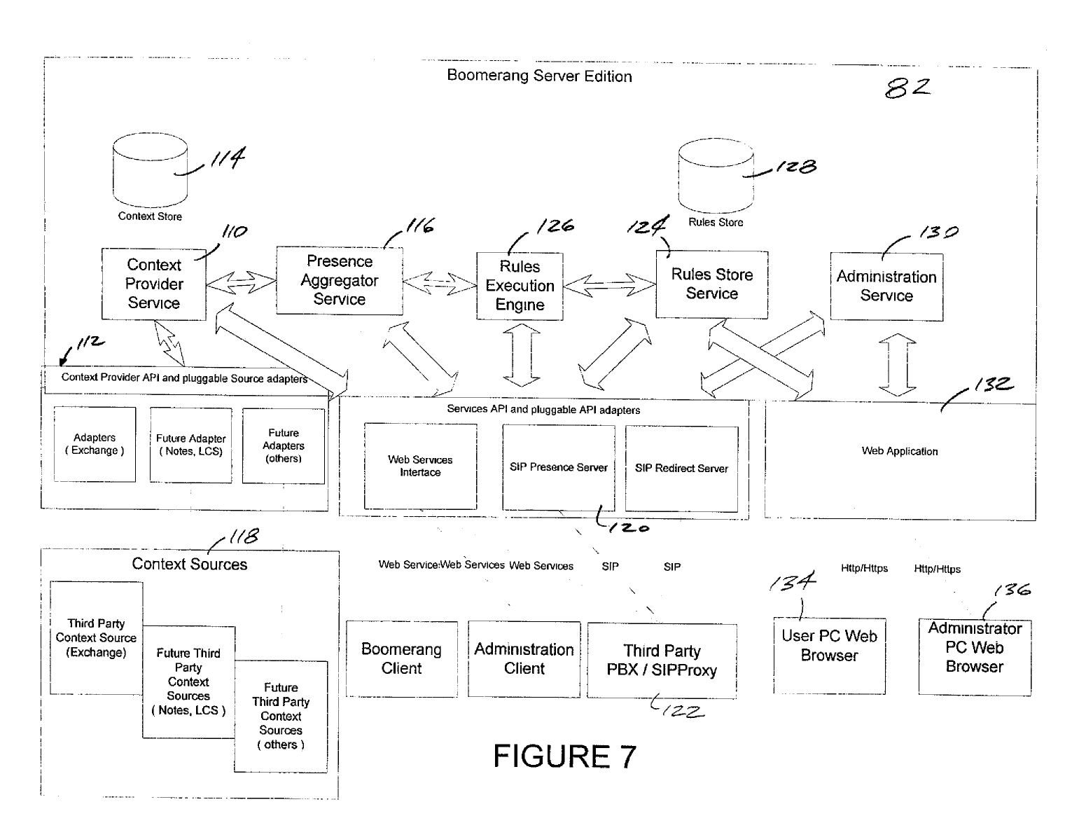

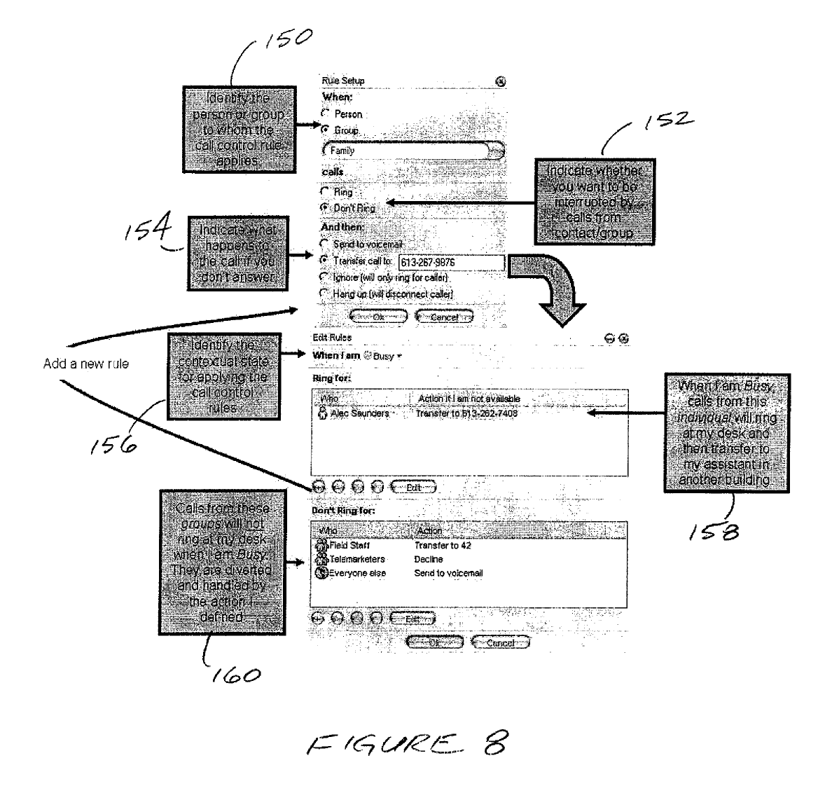

A more detailed server architecture in an embodiment of the invention is presented in FIG. 7. The Boomerang Server 82 is constantly monitoring the users' context sources (for example, their calendar in Exchange) for relevant changes. The Context Provider Service 110 exposes context from heterogeneous sources in a consistent manner so other services can easily get access to relevant context information. Potential context sources include email, contacts, calendar, time-of-day, presence clouds like Microsoft Live Communications Server, LDAP directories, and location services. The Context Provider Service 110 uses Adapters 112 to communicate with the different context sources 118. Adapters 112 are software components that have specific knowledge of the source of context that they access and retrieve. Some of the context related information is cached in the Context Store 114 in order to improve performance.

The context information is used by the Presence Aggregator Service 116 to determine the user's effective presence, the Presence Aggregator Service 116 acting as a presence source, exposing the user's presence to the presence cloud, based on heuristics and context data. For example, when a user's calendar indicates that they are currently in a meeting, Boomerang would automatically update the user's presence to reflect that they are busy. Boomerang achieves this by accessing the calendaring information using the adapter for that source of context. The current presence is published to the outside world using a SIP Presence server 120. The granularity of the presence data exposed to external SIP users 122 is controlled through privacy policies.

Using the Boomerang Client, the user may add, delete or edit rules that determine how his presence is presented to the outside world. These rules use the user's current context and the caller information to determine what action to take (e.g. Accept, decline or redirect the call). Using the rules editor interface, the user can add, modify, delete and prioritize rules to control presence based on the evaluation of one or more conditions These conditions can be selected based on who the Watcher is, the time of day, the day of the week and other similar contextual sources of information.

The client communicates with the Rules Store Service 124 on the server (using web services) where all rules data is stored. The Rules Store Service 124 and the Rules Execution Engine 126 act as the main presence query processing elements, calculating the specific presence for each watcher. They allow the user to set discretionary presence publishing handling policies, and also allow the administrator to set discretionary and mandatory site policies. Rules data may be cached in the Rules Store 128 to improve performance. An example that illustrates how Boomerang's client is used to define call control rules is described hereinafter.

The Administration Service 130 is used for provisioning and modification of accounts. It also allows administrators to set Group level policies

In addition to PC clients, both users and administrators use the Web Application to interact with the system via their respective browsers 134, 136. Users can create and edit their rules and preferences, and Administrators can provision and edit accounts and group rules.

FIG. 8 illustrates an exemplary client interface for defining a typical set of call control rules.

Rules can be defined a-priori or they can be defined in real time as calls come in. Furthermore, the rules definition interface can integrate address book features from existing business applications to make rules creation even easier.

As shown in FIG. 8, a graphic user interface can be provided with fields for:
identifying the person or group to whom the call control rule applies 150;
indicating whether you want to be interrupted by calls from the contact/group 152;
indicating what happens to the call if you do not answer it, such as sending it to voicemail, transferring it to another telephone number, ignoring it, or hanging up 154;
identifying the contextual state for applying the call control rules 156;
identifying persons or groups that the telephone will ring for, and the action that will occur if I am not available 158; and
identifying persons or groups that the telephone will NOT ring for when I am busy, and the action that will occur 160.
   Options and Alternatives

The architectural design described herein supports the feature of call control based on contextual awareness. It also enables support for a number of additional features such as:
1) preferably built entirely on open standards. Boomerang can handle any kind of SIP call, be it a simple voice call or a richer video call;
2) Smart Rule Sets—Call control rules can be defined a-priori and can be defined in real time as calls come in. Furthermore, Boomerang can learn what to do based upon the user's actions and help the user define rules. For example, if the user consistently transfers a particular caller to an extension each time, Boomerang can help the user define a rule that will do it automatically;
3) corporate and global rule sets are supported. For example, a corporate wide rule could be created for a VIP client that ensures they are never directed to voicemail;
4) Operator Console—Boomerang can extend to provide operator consoles, and other specialized contextually-aware user agents; and
5) In/Out Board—Opportunities also exist to build shared applications around the script generation tools for example, an in-out board showing the presence and calendar information of everyone in an office, with administrators capable of updating call control rules and calendars.
   Use Cases

Use Cases/Incoming Inquiry/Basic Scenario
1. A presence inquiry is received
2. The Rule Execution Engine requests for the context of this call from the Context Provider Service
3. The Context Provider Service retrieves the context from the Context Store (cached information) and from the Context Source Adapter. The call context includes information about the Boomerang user and about the caller.
4. The Context Provider Service returns the call context to the Rule Execution Engine.
5. The Rules Execution Engine retrieves the user's rules from the Rules Store.
6. Report presence based on the context and rules defined by the user in the Rule Execution Engine.
7. The use case ends.

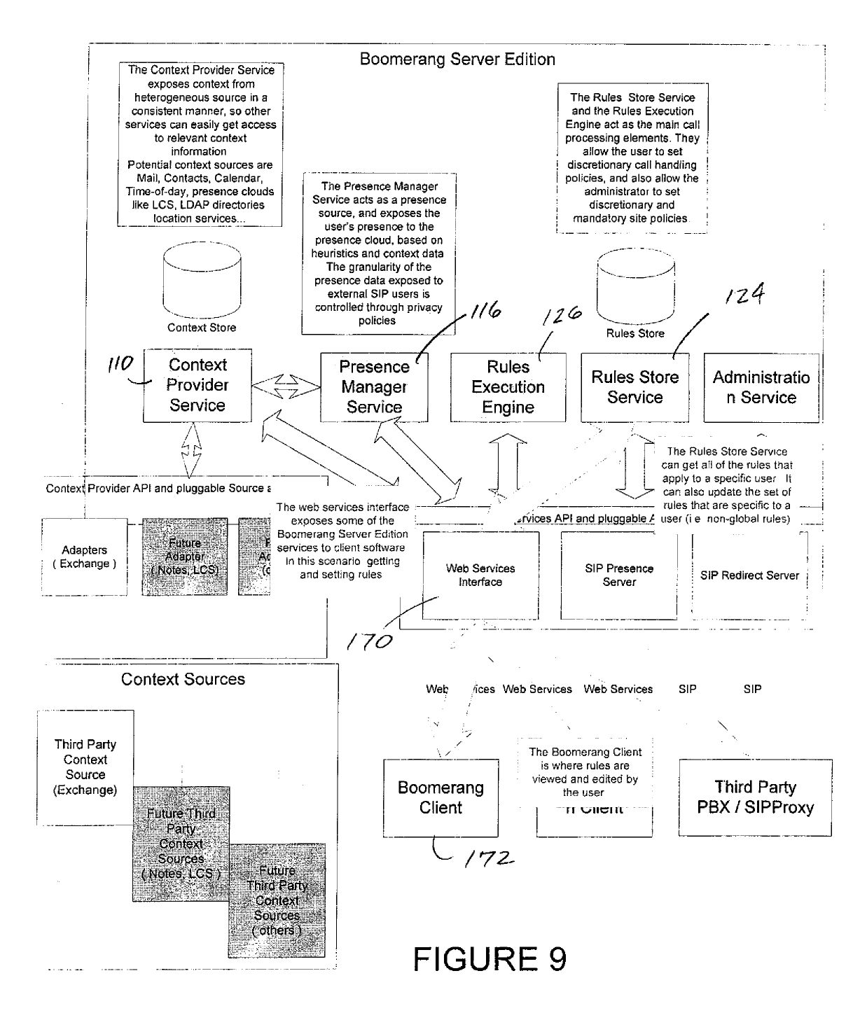

FIG. 9 presents a process flow diagram of the “Viewing and Editing Rules” use cases described hereinafter. The Context Provider Service 110 exposes context from heterogeneous source in a consistent manner, so other services can easily get access to relevant context information. Potential context sources are Mail, Contacts, Calendar, Time-of-day, presence clouds like LCS, LDAP directories, location services The Presence Manager Service 116 acts as a presence source, and exposes the user's presence to the presence cloud, based on heuristics and context data. The granularity of the presence data exposed to external SIP users is controlled through privacy policies.

The Rules Store Service 124 and the Rules Execution Engine 126 act as the main call processing elements. They allow the user to set discretionary call handling policies, and also allow the administrator to set discretionary and mandatory site policies. The Rules Store Service 124 can get all of the rules that apply to a specific user. It can also update the set of rules that are specific to a user (i.e. non-global rules).

The web services interface 170 exposes some of the Boomerang Server Edition services to client software. In this scenario, getting and setting rules. The Boomerang Client 172 is where rules are viewed and edited by the user.

Basic Scenario

1. The use case starts when the user launches the Rule Editor dialog on the Boomerang Client
2. The client requests the rules for the current user from the Boomerang Server.
3. The web service request gets routed to the Rules Store Service on the server which pulls all of the rules for the specified user from the Rules Store. The rules include those that are specific to the user and the global rules that apply to all users.
4. The Rule Store Service replies to the client with the rules.
5. The Rule Editor dialog displays the rules for the current context.
6. The rules that ate specific to the user can be viewed and edited. The global rules can only be viewed.
7. The user presses the OK button on the Rule Editor dialog.
8. The client serializes the rules that are specific to the user (i.e. non-global rules) and sends them to the server using web services.
9. The server receives the web service request and routes it to the Rules Store Service.
10. The Rules Store Service updates the Rules Store, replacing the previous rules for the user with the new ones.
11. The Rule Editor dialog closes on the client.
12. The use case ends

Cancel scenario
1. The scenario begins when the user presses the Cancel button (rather than the OK button) on the Rule Editor dialog.
2. The client does not serialize the rules or send them to the server.
3 The Rule Editor dialog closes on the client.
4. The scenario ends.

The user edits a rule
1. The scenario begins when the user double-clicks on a rule or selects it and presses the edit button. The user cannot edit a global rule.
2. A Rule Setup dialog is displayed It reflects the current settings for the rule being edited (i.e. who it applies to and what action is taken)
3. The user can change the conditions under which the rule will apply (e.g. Identity of caller).
4. The user can change the action to take (e.g. ring, decline, and redirect).
5. The user presses the OK button on the Rule Setup dialog to update the local copy of the rules. The changes will not be finalized until the user presses the OK button on the Rule Editor dialog.
6. The scenario ends

The user adds a rule
1. The scenario begins when a user presses the add button.
2. A Rule Setup dialog appears with default rule settings.
3. The user sets the conditions under which the rule will apply (e.g. Identity of caller).
4. The user sets the action to take (e.g. ring, decline, and redirect).
5. The user presses the OK button on the Rule Setup dialog to update the local copy of the rules The changes will not be finalized until the user presses the OK button on the Rule Editor dialog.
6. The scenario ends.

The user deletes a rule
1. The scenario begins when a user presses the delete button or selects a rule and presses the DELETE key. The user cannot delete a global rule.
2 The deleted rule is removed from the local copy of the rules. The change will not be finalized until the user presses the OK button on the Rule Editor dialog
3. The scenario ends.

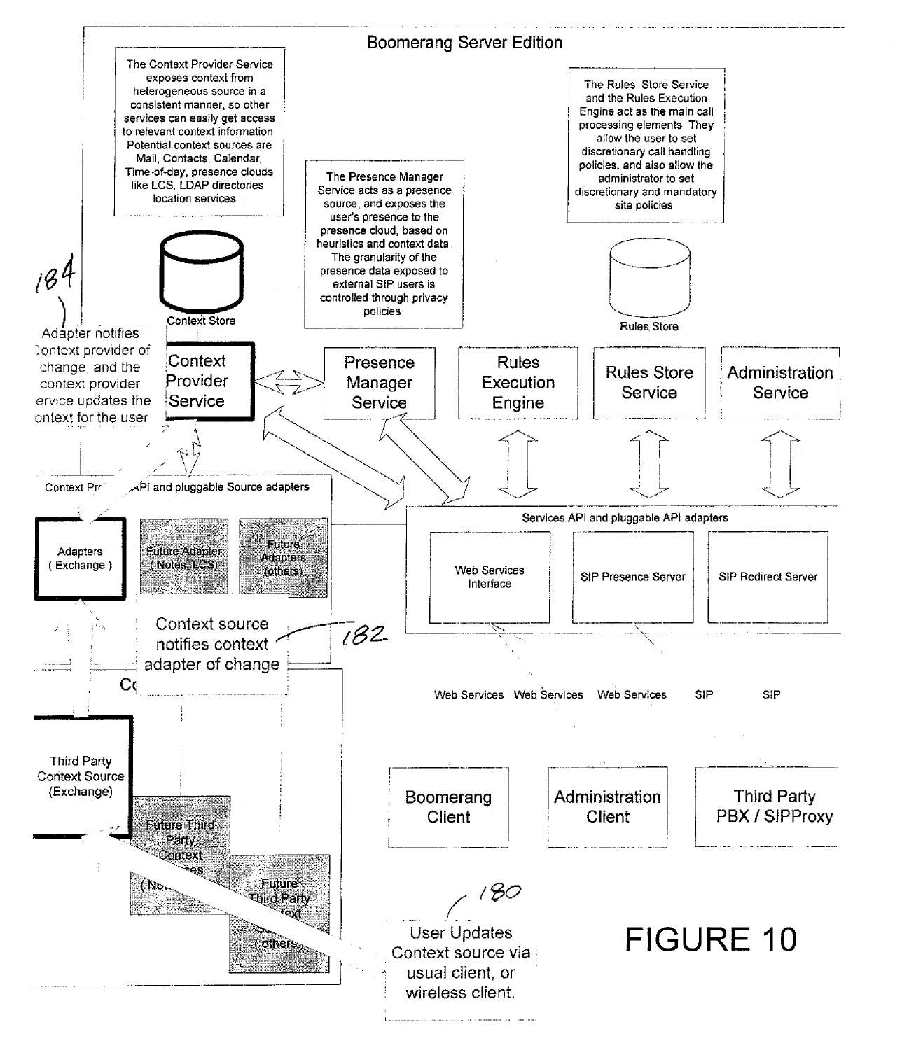

FIG. 10 presents a process flow diagram for the “Process Context Updates from a Wireless” user case. In short, the User updates his context source via the usual client, or wireless client 180. The Context source then notifies the context adapter of the change 182 The Adapter then notifies the Context provider of the change, and the context provider service updates the context for the user 184.

Device (Blackberry)
1. The use case starts when the user updates a Contextual Element (e.g. their calendar) on their wireless device (e.g. a Blackberry),
2. The synchronization mechanism intrinsic in the wireless device (Blackberry) applies the change to the user's Context Provider (e.g. MS Exchange),
3. The Context Provider (MS Exchange) updates itself accordingly (e.g. updates its calendar),
4. The Context Provider Service receives an event from Context Provider (MS Exchange) that describes the update,
5. The Context Provider Service informs the Presence Manager service,
6. The Context Provider service re-computes the user's Contextual State,
7. The Rules Execution engine applies call control rules that are appropriate for the new contextual state the next time a call comes in,
8. The use case ends.

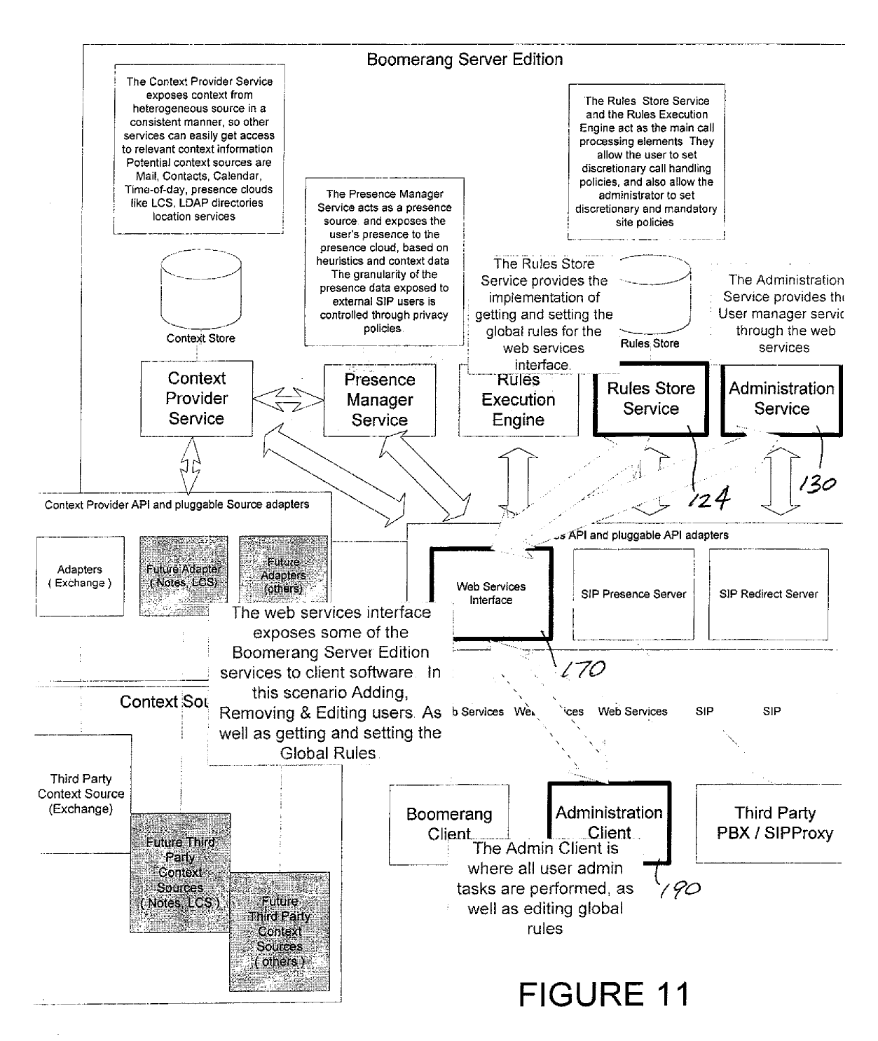

FIG. 11 presents an exemplary process flow diagram of the “Administration Console Interaction” use cases described hereinafter.

The Admin Client 190 is where all user administrative tasks are performed, as well as the editing of global rules. The web services interface 170 exposes some of the Boomerang Server Edition services to client software; in this scenario Adding, Removing & Editing users, as well as getting and setting the Global Rules. The Rules Store Service 124 provides the implementation of getting and setting the global rules for the web services interface, and the Administration Service 130 provides the User manager service through the web services.

Basic Scenario
1 The use case starts with the administrator launching the Boomerang Server Admin Client
2. The client do not launches, presenting the admin with a logon
3 The administrator authenticates with their login id and password
4. The client User Interface presents the administrator with the options—Edit global rules, Add User, Remove User, Edit User
5. The user chooses Edit Global Rules
6. The current global rules are downloaded from the server via the web services interface.
7. The admin user is presented with the rules editing User Interface, this is the same User Interface as used in the Boomerang Client. The current rules are displayed in the User Interface.
8. The admin user adds a new rule to forward all calls outside of business hours to voicemail
9. The admin user finishes editing the rules and saves.
10. The admin client pushes the rules up to the server via web services, where they immediately replace the previous global rules for all incoming calls.
11. The admin user shutdowns the client, the client application exits.
12. The use case ends

Add User
1. Repeat steps 1 to 4 in the Basic Scenario.
2. The admin user chooses add user
3. The admin user is presented with User Interface to specify the details for the user. There is a minimum set of info which is required to add a user and the ‘add’ button is not enabled until that minimum is met.
4. The user info includes name, userid, context source locations.
5. When the admin user chooses to ‘add’ user the information is pushed to the Boomerang server using the web-services.
6. On server, a new account is created, after checking for duplicate users Any context sources provided ate configured from the info provided
7. If the action is successful the add user dialog dismisses
8. If the add user is not successful, the admin user is given error information, and returned to the add user dialog to try again.
9. The use case ends.

Delete User
1. Repeat steps 1 to 4 in the Basic Scenario.
2. The user chooses delete user.
3. The admin client requests a list of user's from the boomerang server
4. The admin user selects a user from the list and chooses delete.
5. The delete request is sent to the Boomerang Server via the web services interfaces.
6. The server removes the user and all associated data from the server stores.
7. The client indicates successful deletion.
8. The use case ends.

Edit User
1. Repeat steps 1 to 4 in the Basic Scenario.
2. The user chooses edit user.
3. The admin client requests the list of user's from the Boomerang Server via web services.
4. The Boomerang server iterates over the user store, and returns a list of all user ids and user names,
5. This list is presented to the admin user. The admin user selects a user and chooses to edit.
6. The admin client requests the user details via web services.
7. The Boomerang server pulls the details from the user store and returns all the editable details
8 The admin user changes the details in the User Interface and selects Save
9. The admin client pushes the details to the Boomerang Server via web services where they are validated and if valid, updated in the store. If not valid, error information is returned
10. If successfully save the user detail dialog closes, if not the admin user is given a chance to make changes and try again.
11. The use case ends.

The present invention has been described with regard to one or more embodiments However, it will be apparent to persons skilled in the art that a number of variations and modifications can be made without departing from the scope of the invention as defined in the claims.

For example, the method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention maybe executed by a computer processor or similar device programmed in the manner of method steps, or may be executed by an electronic system provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network

The invention could, for example, be applied to computers, smart terminals, personal digital assistants and Internet-ready telephones. Again, such implementations would be clear to one skilled in the art, and do not take away from the invention

All citations are hereby incorporated by reference.

What is claimed is:

1. A method of responding to a presence inquiry for a given user comprising the steps of:
establishing context parameters for said user;
establishing rules to govern responses to presence inquiries, said rules relying on values/states of said context parameters;
determining values/states of context parameters at time of said presence inquiry, including identifying the party making said inquiry;
establishing a presence response with respect to said established rules and said values/states of context parameters at time of said presence inquiry; and
reporting said presence response to said inquiring party.

2. The method of claim 1 wherein said step of establishing rules comprises the steps of:
launching a rules wizard to present exemplary scenarios and options to said user; and
storing rules values identified by said user.

3. The method of claim 1 further comprising the step of:
storing said presence response sent to said inquiry party, indexing said stored presence response with respect to an identifier for said inquiring party.

4. The method of claim 1 further comprising the steps of:
in response to a request to change said established rules, being received from said user:
launching said rules wizard, populating fields in said rules wizard with said stored rules values;
storing new rules values identified by said user; and
re-calculating the values of stored presence responses

5. The method of claim 1 further comprising the steps of:
in response to a change in the context of said user, re-calculating the values of stored presence responses.

6. The method of claim 1 wherein said user's available communications devices includes at least one selected from the group consisting of:
Cellular telephone;
Personal digital assistant;
Personal computer;
Internet-ready telephone;
Voice over IP telephone;
Television set-top box.

7. The method of claim 1 wherein said contextual criteria includes at least one criterion selected from the group consisting of:
Day and Time,
On/Off hook of communication devices,
Relationship to watcher,
Current activity,
Who is the watcher,
PC activity,
Communication history with watcher,
Velocity of user (driving, running etc.),
Mood of user,
Ambient noise and environment, and
Location of user.

8. The method of claim 1 further comprising the step of integrating said presence response data into the functionality of an existing business application.

9. The method of claim 1 further comprising the step of generating a unique presentity identification based on the user and Watcher identification.

10. The method of claim 1 further comprising the step of executing an advanced heuristics algorithm to detect communication patterns, and using this pattern detection to modify the user's rules.

11. The method of claim 1, further comprising the step of examining the communication history between the user and the watcher by executing a Heuristics/Artifical Intelligence algorithm, enabling more intelligent presence publishing decisions.

12. A telecommunications system comprising:
a telecommunications network;
a plurality of User interface devices;
means for enabling said End User to set up rules for governing presence publishing;
means for establishing contextual parameters for said End User; and
means for coordinating communications between said telecommunications network and said plurality of User interface devices, with consideration for the contextual state of an End User.

13. The system of claim 12, wherein said means for coordinating communications comprises a desktop PC application which:
allows the user to specify rules for given contexts;
interfaces desktop context information to a communications server; and
performs call control between the End User and a third party phone device or software.

14. The system of claim 12, comprising a hierarchy concept of rules and policies that allow for global and individual rules processing.

15. The system of claim 12, comprising a context plug-in architecture that facilitates the introduction of new sources of context within the system.
